(19) United States
(12) Patent Application Publication
(10) Pub. No.: US 2008/0081098 A1
(43) Pub. Date: Apr. 3, 2008

(54) Produce cutting machine

(76) Inventor: Orval Zane Burke, Salinas, CA (US)

Correspondence Address: Erick P. Wolf, 1301 Dove Street, #1050, Newport Beach, CA, 92660, US

(21) Appl. No.: 11/541,288

(22) Filed: Sep. 28, 2006

(51) Int. Cl. A23P 1/00

(52) U.S. Cl. 426/518

(57) ABSTRACT

A produce cutting machine may include a supporting structure, an endless conveyor coupled to the supporting structure and produce holding cups coupled to the endless conveyor. A pivoting cutting frame may house cutting assemblies with curved cutting blades configured to cut produce. The pivoting cutting frame may pivot to a lowered position above the endless conveyor to locate the cutting assemblies in a cutting location. A primary connecting rod may synchronically couple the endless conveyor with the pivoting cutting frame such that the produce holding cups and cutting assemblies converge at the cutting location. At convergence, a positional sensor may trigger an actuator to close the cutting assemblies and cut the produce. With produce such as broccoli and cauliflower, the cutting may produce florets.

### FIELD OF THE INVENTION

This invention is generally related to produce cutting machines, and more particularly to a produce cutting machine having synchronized conveyor and cutting components. The machine is adapted to transport produce along the conveyor to a cutting location where the produce is cut into desirable portions such as florets. Produce applications include, but are not limited to, broccoli, cauliflower, and romaine lettuce.

### BACKGROUND OF THE INVENTION

Vegetables such as broccoli, cauliflower, and romaine lettuce and others are still frequently trimmed by hand. As to broccoli and cauliflower, the desirable “florets” are predominately hand trimmed because machine processing may damage the vegetable. Broccoli forms a head consisting of green buds and thick, fleshy flower-stalks. The heads are looser than those of cauliflower and generally green-colored, and the flower stalks are longer. Broccoli heads vary in size, commonly attaining a diameter of six inches or more. Broccoli heads are generally harvested when the buds are still small and tightly closed, and before the heads are fragmented.

Cauliflower heads are generally harvested when they are 5-6 inches in diameter. The heads are easily damaged and need to be handled with great care. Cauliflower is generally hand harvested into large bins for processing. Harvester aids are commonly used to convey cauliflower from the cutting crew to the bins.

Florets are generally the tight, branched clusters of flower buds that together form a head of cauliflower or broccoli. The edible portion of the broccoli plant consists of the tender stem and the unopened flower buds or florets. Machine cutting the vegetables to produce florets may result in pieces of widely varying size that may not cook at the same rate.

Because lettuce is so fragile, it is handled as little as possible. Most fresh market lettuce is hand cut and trimmed, and placed in cardboard cartons in the field. Cut lettuce, which is found in grocery stores in plastic bags sometimes labeled as “ready to eat,” is harvested in a different fashion. Crews hand cut and core the lettuce and place it in bulk containers which are transported to a processing facility.

While machinery exists to cut such vegetables, these machines are frequently complicated and as such, very expensive to purchase and maintain. These costs may exceed the cost of labor, especially in areas of the country such as the Salinas Valley of California and in Mexico were labor is abundant and relatively inexpensive.

### SUMMARY OF THE INVENTION

A produce cutting machine may include a supporting structure, a pivoting cutting frame coupled to the supporting structure and housing cutting assemblies, an endless conveyor coupled to the supporting structure and produce holding cups coupled to the endless conveyor. The produce holding cups may be arranged in rows and columns along the endless conveyor and may be conveyable to and from a cutting location within the produce cutting machine.

The endless conveyor may include a conveyor belt with produce holding cups mounted thereon, a rotational power source such as an electric motor coupled to a gearbox, a drive axle coupled to the gearbox and running through the conveyor belt, and gears coupled around the drive axle and configured to drive the conveyor belt. A crank may be coupled to the drive axle and rotate about the drive axle's axis.

The pivoting cutting frame may be configured to pivot between a lowered position where the cutting assemblies are positioned in the cutting location to cut produce and a raised position where the cutting assemblies are raised to permit the produce to enter the cutting location. The pivoting cutting frame may include a supporting frame housing the cutting assemblies and a pivoting axle coupled to the supporting frame. A pivoting arm may be coupled to the pivoting axle and pivot about the pivoting axle's axis.

A primary connecting rod may rotationally couple the pivoting arm of the pivoting cutting frame to the crank of the endless conveyor so that as the produce holding cups travel to and from the cutting location, the pivoting cutting frame pivots between lowered and raised positions. The pivoting cutting frame and endless conveyor may be synchronized such that at predetermined intervals the produce within the produce holding cups and the cutting assemblies cyclically converge at the cutting location.

Each cutting assembly may include a set of two curved cutting blades. Each set of curved cutting blades may share a common pivoting. The curved cutting blades may define cutting assembly opened and closed positions, the opened position may be suitable for encircling of portion of produce and the closed position may be suitable for cutting the produce.

One or more secondary connecting rods may open and close the cutting assemblies. Each secondary connecting rod may be coupled at a first end to one curved cutting blade and at a second end to an upper pivoting assembly. The secondary connecting rods may be configured to pull and push the curved cutting blades to open and close the curved cutting blades, respectively, about their pivoting axis. The upper pivoting assembly may be pivotally coupled to a supporting mast and the supporting mast may be rigidly coupled to the supporting frame of the pivoting cutting frame.

An actuator for directing the opening and closing of the cutting assemblies may be a pneumatic actuator with a cylinder and a telescoping rod. The cylinder may be coupled to the supporting frame and the telescoping rod may be coupled to the upper pivoting assembly. The telescoping rod may extend to rotate the upper pivoting assembly forward about the supporting mast; the upper pivoting assembly may then push the secondary connecting rods downwards to close the curved cutting blades to cut the produce. Likewise, when the telescoping rod retracts, it may rotate the upper pivoting assembly backwards about the supporting mast, the upper pivoting assembly may then pull the secondary connecting rods upwards to open the curved cutting blades.

A positional sensor may be used to trigger the pneumatic actuator. The positional sensor may include a snap action switch having a tensioned activating lever that compresses to trigger the pneumatic actuator to extend the telescoping rod. The tensioned activating lever may ride on a rotating cam coupled to the drive axle of the endless conveyor. A lobe on the cam may be configured to compress the tensioned activating lever of the snap action switch to trigger the pneumatic actuator. The location of the lobe may correspond to the convergence of the produce holding cups and cutting assemblies at the cutting location. Accordingly, as the endless conveyor rotates, the tensioned activating lever of the snap action switch may follow the cam and periodically trigger the pneumatic actuator to close the cutting assemblies and cut the produce. After the lobe passes the tensioned activating lever, the positional sensor may signal the pneumatic actuator to retract the telescoping rod and open the cutting assemblies to prepare for another cutting cycle.

In application, two users may operate the produce cutting machine by placing produce into the produce holding cups from each side of the produce cutting machine. The produce may be inserted upside down and may conformably rest in the produce holding cups. The conformable fit may enable the produce holding cups to securely transport the produce along the produce cutting machine. The endless conveyor, powered by the rotational power source, may then transport the produce along a horizontal upper run to the cutting location. When the produce approaches the cutting location, the pivoting cutting frame may pivot downwards. At a time before the cutting assemblies and produce converge, the telescoping rod of the pneumatic actuator may retract and therefore rotate the upper pivoting assembly backwards to pull the secondary connecting rods upwards to open the curved cutting blades of the cutting assemblies. The cutting assemblies in the open position may thereafter converge with and encircle a portion of the produce.

At or near the time when the cutting assemblies and produce converge, the tensioned activating lever may compress and trigger the telescoping rod of the pneumatic actuator to extend, thus rotating the upper pivoting assembly forward to push the secondary connecting rods downward to close the curved cutting blades and therefore cut the produce. After the produce is cut, the waste may be disposed of and the produce holding cups may transport the desirable portion, such as the florets, to another conveyor for further transportation and sorting. The cycle may continuously repeat itself with the endless conveyor and pivoting cutting frame rotating at a constant or intermittent pace.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 is a perspective cut-away view of a produce cutting machine;

FIG. 2 is a cut-away rear view of a produce cutting machine;

FIG. 3 is a side view of the produce cutting machine;

FIG. 4 is a side view of the produce cutting machine;

FIG. 5 is a partial perspective cut-away view of a produce cutting machine;

FIG. 6 is a perspective view of a produce holding cup of a produce cutting machine;

FIG. 7 is a top cut-away view of a produce cutting machine;

FIG. 8 is a partial perspective cut-away view of a produce cutting machine;

FIG. 9 is a partial cut-away rear view of a produce cutting machine;

FIG. 10 is a partial perspective view of a produce cutting;

FIG. 11 is a partial perspective view of a produce cutting;

FIG. 12 is a partial perspective cut-away view of a produce cutting machine;

FIG. 13 is a perspective view of a produce cutting machine; and

FIG. 14 is a perspective view of a produce cutting machine.

### DETAILED DESCRIPTION OF THE INVENTION

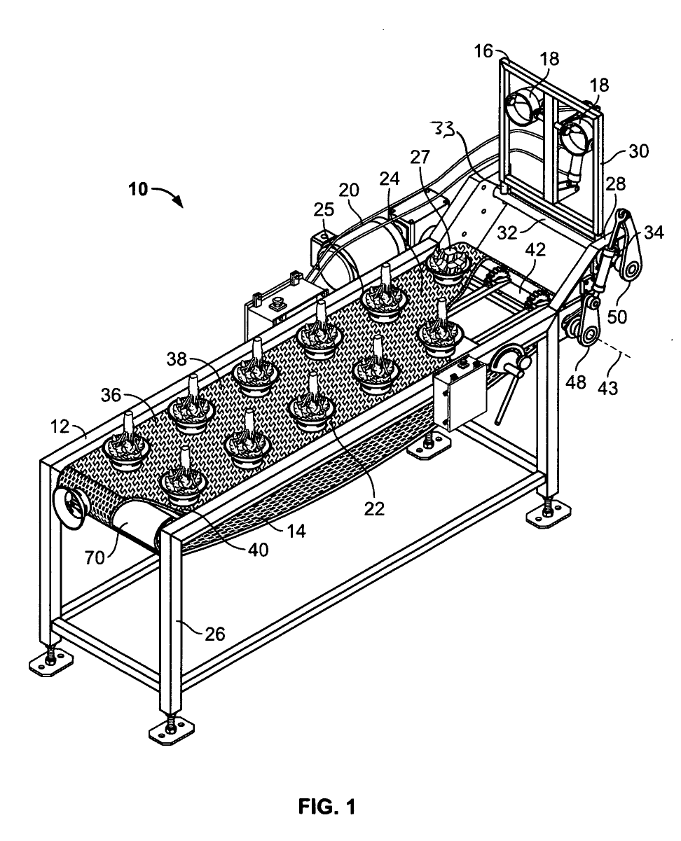

Some embodiments are described in detail with reference to the related drawings of FIGS. 1 through 14. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

As shown in FIG. 1, one embodiment of a produce cutting machine 10 includes a supporting structure 12, an endless conveyor 14 coupled to the supporting structure, a pivoting cutting frame 16 pivotally coupled to the supporting structure and housing two cutting assemblies 18, a rotational power source 20 coupled to the supporting structure, and a series of produce holding cups 22 coupled to the endless conveyor. The produce holding cups are arranged in two columns and multiple rows along the endless conveyor and conveyable to and from a cutting location 24 within the produce cutting machine. In this embodiment, the produce cutting machine is configured to cut broccoli to produce broccoli florets.

The supporting structure 12 includes an elongate frame 26 manufactured from welded together boxed-stainless steel tubing and a pair of stainless steel supporting brackets 28 welded onto the boxed-stainless steel tubing. The supporting structure is configured to support the components of the produce cutting machine 10 and to provide structural integrity. Stainless steel is used because it is non-toxic, rust-resistant, and zinc and lead-free.

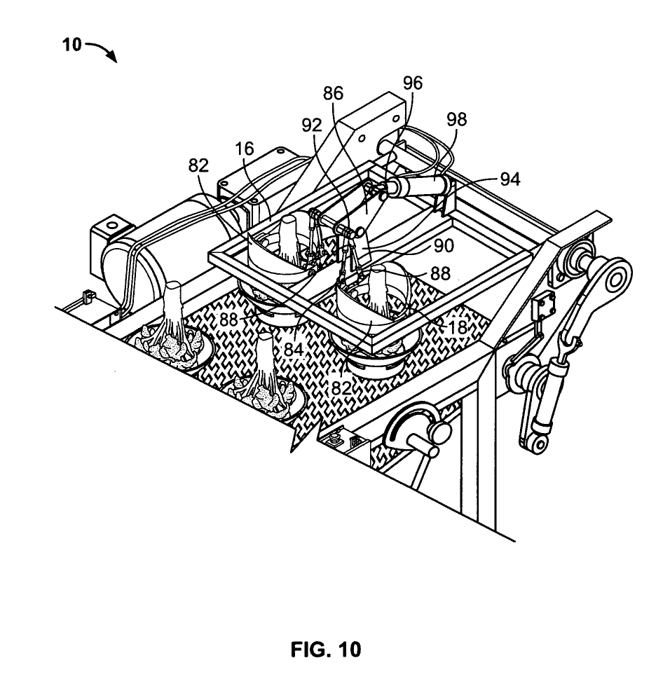

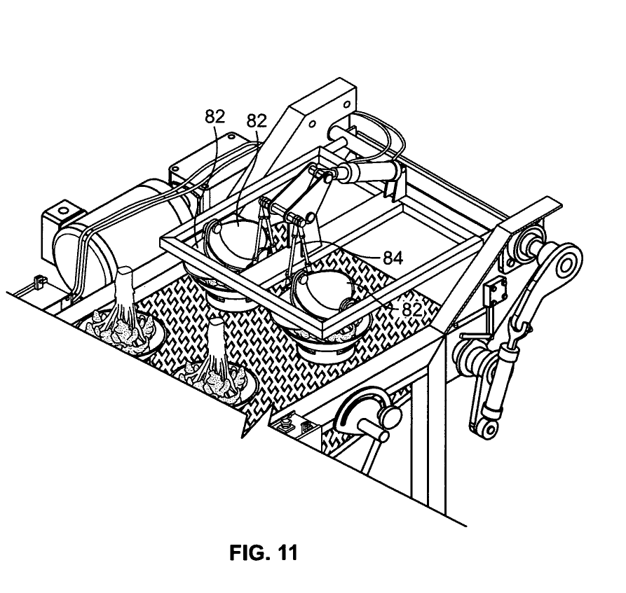

The pivoting cutting frame 16 pivots between a substantially horizontal lowered position (shown in FIGS. 10 and 11) for cutting produce and a substantially vertical raised position shown here. The substantially vertical position permits produce to freely enter into the cutting location 24 without contacting the pivoting cutting frame or cutting assemblies 18 therein. As shown in FIG. 1, a first row 25 of produce holding cups 22 is progressing to the cutting location while a second row 27 has already passed the cutting location. The second row has cut broccoli florets remaining in the produce holding cups for further transport. The pivoting cutting frame includes a supporting frame 30 housing the cutting assemblies and a pivoting axle 32 rigidly coupled to the supporting frame through two tubular members 33. The pivoting cutting frame may be moved away from and closer to the pivoting axle by adjusting its position on the tubular members. This adjustment will correspondingly alter the cutting location 24. The pivoting cutting frame is supported by supporting brackets 28 and pivotally coupled to the supporting brackets through two bearings 34. Similar to the construction of the supporting structure, the supporting frame is manufactured from welded together boxed-stainless steel tubing.

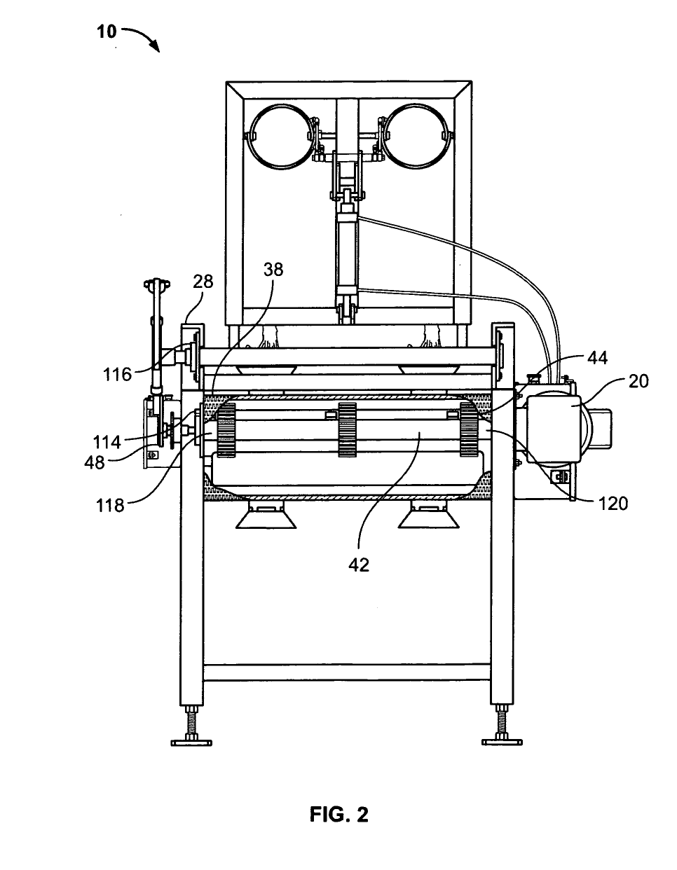

The endless conveyor 14 is coupled to the elongate frame 26 and configured to convey the produce holding cups 22 along an upper run 36 of a conveyor belt 38 from an intake location 40 of the produce cutting machine 10 to the cutting location 24. The endless conveyor includes a rotational power source 20, a drive axle 42 coupled to the rotational power source and passing through the conveyor belt, and, as shown in FIG. 2, three gears 44 coupled around the drive axle and inherently supporting a first rotational location of the conveyor belt. The gears are configured to interface with and drive the conveyor belt. A curved sheet underneath the conveyor belt is configured to provide a sliding rotation point for the conveyor belt while also inherently supporting a second rotational location of the conveyor belt.

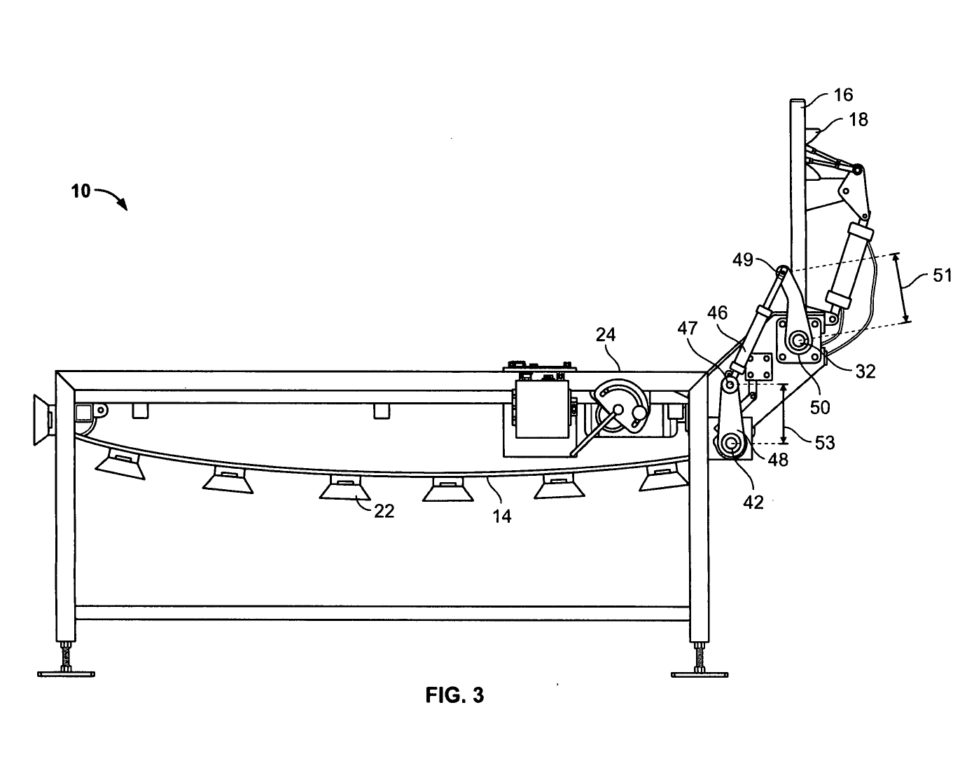

Turning to FIG. 3, a primary connecting rod 46 synchronizes the endless conveyor 14 with the pivoting cutting frame 16 such that as the produce holding cups 22 are transported to and from the cutting location 24, the pivoting cutting frame moves between the lowered position (shown in FIGS. 10 and 11) to cut the produce and the raised position shown in FIG. 3 to permit the produce to enter the cutting location. In particular, a lower end 47 and an upper end 49 of the primary connecting rod rotationally couple a crank 48 coupled to the drive axle 42 with a pivoting arm 50 coupled to the pivoting axle 32, respectively.

Referring back to FIG. 1, the pivoting arm 50 is rigidly coupled to the pivoting axle 32 of the pivoting cutting frame 16 such that the pivoting arm and pivoting cutting frame move in unison. For example a ninety-degree rotation of the pivoting cutting frame corresponds to a ninety-degree rotation of the pivoting arm. Similarly, the crank 48 is rigidly coupled to the drive axle 42 of the endless conveyor 14 such that the crank and drive axle move in unison. For example, a three hundred and sixty degree rotation of the drive axle corresponds to a three hundred and sixty degree rotation of the crank.

Referring back to FIG. 3, when coupled by the primary connecting rod 46, one rotation of the crank 48 corresponds to less than an entire revolution of the pivoting arm 50. The relationship between the respective movements of the crank and the pivoting arm are due to the differences in radii between the crank and pivoting arm. More particularly, the movement of the pivoting arm 50 defines an arc with a first radius (also referred to as “pivoting arm radius”) 51 and the movement of the crank defines a circle with a second radius (also referred to as “crank radius”) 53. Because the pivoting arm radius is larger than the crank radius, when the pivoting arm is coupled with the crank through the primary connecting rod, the pivoting arm pivots less than three hundred and sixty degrees with a complete revolution of the crank. In this particular configuration, continuous rotation of the endless conveyor 14 corresponds to the pivoting cutting frame 16 pivoting between predetermined substantially vertical upper and substantially horizontal lower positions corresponding to approximately one hundred and eighty degrees of total movement. The ratio of pivoting arm radius to crank radius is such that a complete cycle consisting of the pivoting cutting frame pivoting from its lowered position to its raised position and back to its lowered position corresponds to cutting one row of produce. In this manner, the pivoting cutting frame and endless conveyor are synchronized such that when rows of produce in the produce holding cups 22 enter the cutting location 24, the pivoting cutting frame lowers and locates the cutting assemblies 18 to converge with the produce holding cups and cut the produce. The cycle repeats itself for every row of produce holding cups as the endless conveyor rotates. Varying the ratio of the crank and pivoting arm radii alters the total swept area of the pivoting cutting frame while varying the length of the primary connecting rod moves the pivoting cutting frame's upper and lower positions.

In an alternative embodiment, an endless conveyor and pivoting cutting frame may be coupled electronically. In this embodiment a sensor may be used to trigger the pivoting cutting frame to motion upwards and downwards. The pivoting frame would still be synchronized as shown in the accompanying figures, however there would be no primary connecting rod coupling the endless conveyor with the pivoting cutting frame. Similarly, there would not necessarily be a need for a crank or pivoting arm. The pivoting cutting frame would therefore be pivoted by an electric motor. This configuration would maintain the synchronous relationship between the endless conveyor and the pivoting cutting frame and would remove the bearing and moving parts associated with the primary connecting rod, crank, and pivoting arm. This alternative embodiment may be configured so that the pivoting frame pivots between substantially horizontal and substantially vertical position as shown in the accompanying figures or in other manners as specified.

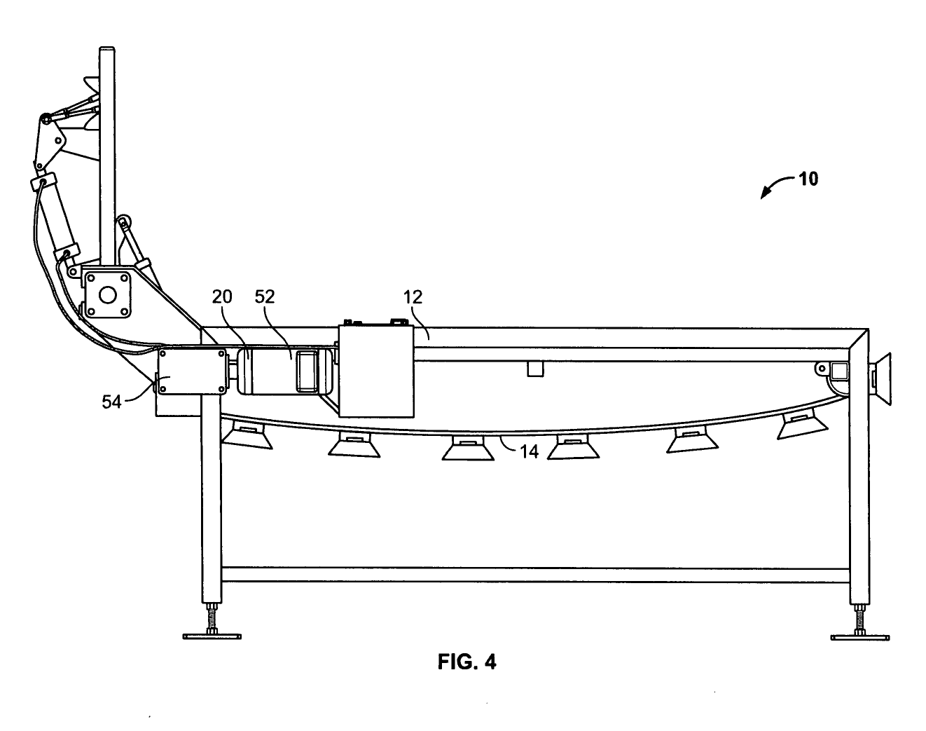

Referring now to FIG. 4, the rotational power source 20 driving the endless conveyor 14 comprises an electric motor 52 coupled to a gearbox 54. The electric motor and gearbox are mounted horizontally on the supporting structure 12. The electric motor in this embodiment is configured to operate continuously. As shown in FIG. 2, the gearbox transfers the electric motor's rotational output to the drive axle 42. In an alternative embodiment, a power source may comprise a hydraulic motor coupled directly to a drive axle or through a gearbox to a drive axle. In another alternative embodiment, a power source may include a motor configured to intermittingly rotate an endless conveyor. With intermittent rotation of the endless conveyor, produce holding cups and a pivoting cutting frame may also move intermittently by way of a synchronized relationship among these components. In such a configuration, produce cutting machine operators may have additional time to load the produce holding cups, as the produce holding cups would be intermittently stationary.

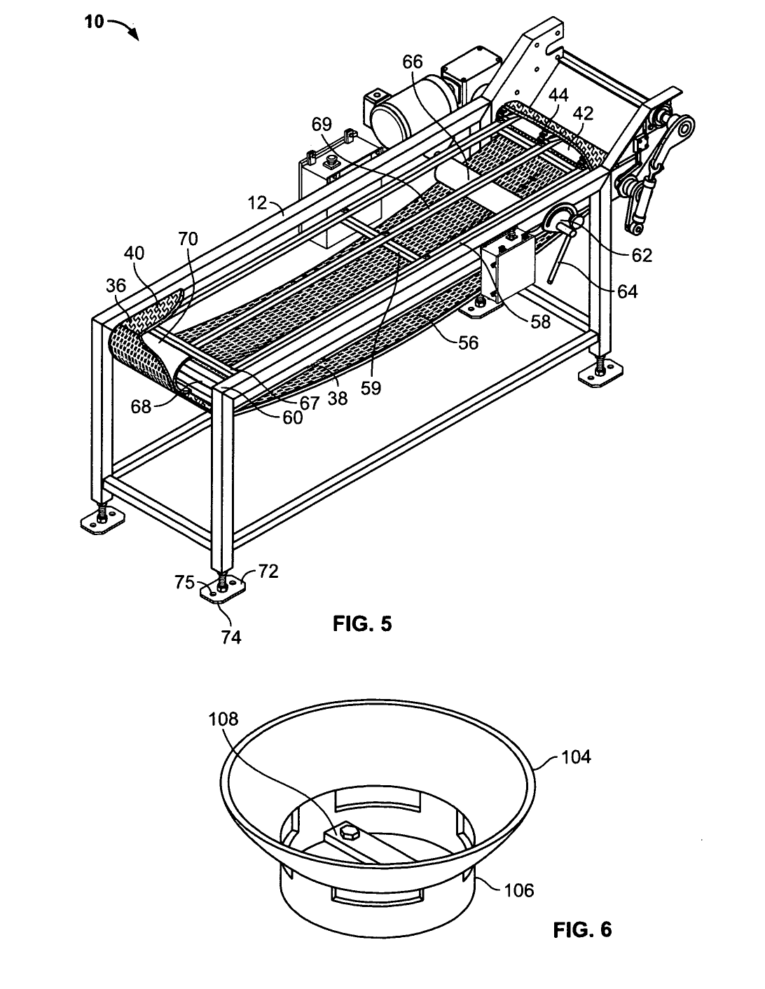

Turning to FIG. 5, the conveyor belt 38 comprises a plastic interwoven belt suitable for use in connection with food handling equipment. The interwoven belt is comprised of a series of links and forms an upper run 36 and a lower run 56 where each run is configured to span approximately the length of the produce cutting machine 10. The links of the interwoven belt interact with the gears 44 to rotate the conveyor belt and transport the produce holding cups 22 (shown in FIG. 1) from the intake location 40 to the cutting location 24 (also shown in FIG. 1) along the upper run and back again via the lower run. The upper run slides along longitudinal elongate members 58 with supporting crossbeams 59 therein. The longitudinal elongate members are situated within the supporting structure 12 and pivotally coupled to the supporting structure near the distal end 60 of the produce cutting machine 10 at a pivoting coupling 68. The longitudinal elongate members run substantially parallel along the length of the produce cutting machine and include top portions suitable for providing a sliding surface for the conveyor belt to ride on. A conveyor height adjusting mechanism 62 supports a proximal portion 69 of the longitudinal elongate members.

The conveyor height-adjusting mechanism 62 includes an eccentrically mounted rotating cylinder 66 configured to raise and lower the longitudinal elongate members 58 to alter the relationship of the producing holding cups 22 and cutting assemblies 18. The conveyor height-adjusting mechanism rides in bearings and is coupled to the underside of the supporting structure 12. A rotary arm 64 is rigidly coupled to the eccentric rotating cylinder so that as the rotary arm is rotated, the eccentric rotating cylinder rotates in unison. The eccentric rotating cylinder and the longitudinal elongate members interact such that as the eccentric rotating cylinder is rotated, it changes the height of the longitudinal elongate members, thus changing the height of the upper run 36 of the conveyor belt 38. Raising or lowering the longitudinal elongate members therefore alters the proximity of the holding cups to the cutting assemblies and therefore affects the depth of the cut. A user can accordingly alter the height of the upper run according to the type and size of produce to be cut by rotating the eccentric rotating cylinder through manipulation of the rotary arm.

In an alternative embodiment, a conveyor belt may be supported on its distal end by a plurality of wheels. The wheels may be configured to interface with and rotate with a conveyor belt as produce holding cups are conveyed. In another alternative embodiment, a conveyor belt may include a plurality of chains spanning longitudinally along the machine, the plurality of chains coupled transversely by a plurality of rigid beams. A base of each produce holding cup may be coupled to an outer surface of the beam by a plurality of nut and bolt couplings wherein the bolts extend from base of the produce holding cups through the beam and are secured by nuts located on an inner surface of the beam. In another alternative embodiment, a conveyor belt may be supported on its distal end by a plurality of guiding pads over which the conveyor belt may rotate. The pads may be manufactured partly from a plastic material and configured to resemble a semicircular shape to conformably interact with the conveyor belt.

Still referring to FIG. 5, a curved sheet 70 is coupled to the distal end 60 of the produce cutting machine 10 and shaped in a semi-circular fashion. The curved sheet is welded to the supporting structure 12 and approximately the same width as the conveyor belt 38. The curved sheet provides a smooth surface on which the conveyor belt may rotate about the produce cutting machine and eliminates the need for moving parts including axles and wheels for supporting the conveyor belt's rotation near the distal end of the produce cutting machine. The curved sheet is manufactured from stainless steel but in the alternative may be manufactured from plastic, aluminum, and other types of materials suitable for this food processing application.

The produce cutting machine 10 may be raised or lowered by adjusting four height-adjustable pedestals 72 located underneath the four corners of the supporting structure. The height-adjustable pedestals may be adjusted to raise or lower individual corners of the produce cutting machine or to raise or lower the entire machine. In this embodiment, the height-adjustable pedestals are threaded into bolts, which are welded to the supporting structure 12. The height-adjustable pedestals are also configured with bases 74 with orifices 75 therein. The orifices are configured to support a secure attachment to a structure such as a truck bed through a plurality of nut and bolt couplings. When coupled to a truck bed, the produce cutting machine is securely portable to and from job locations and can be used to cut produce even while on the truck bed.

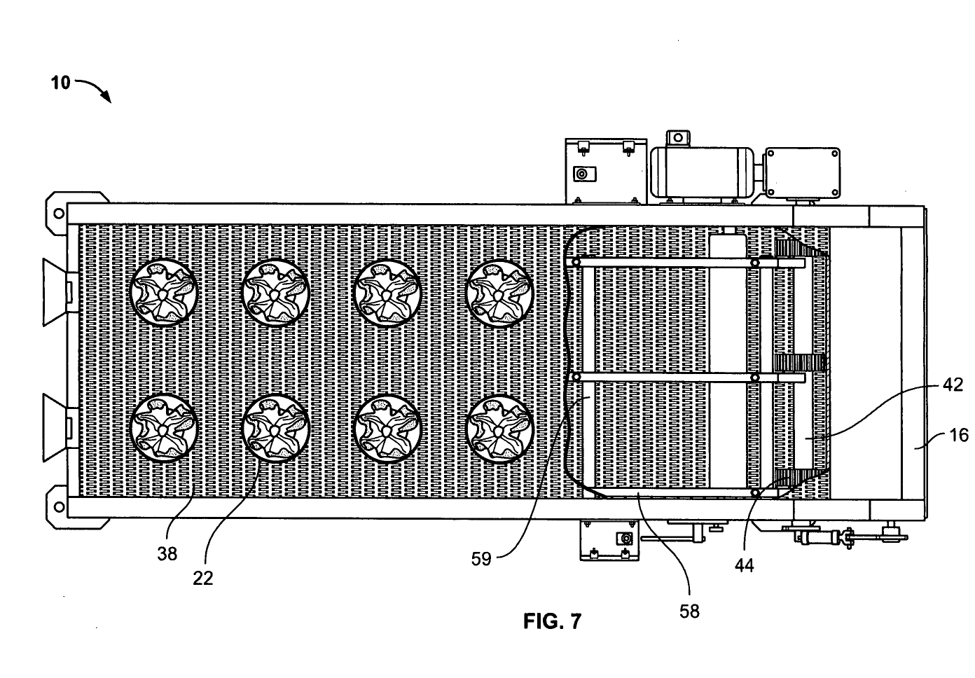

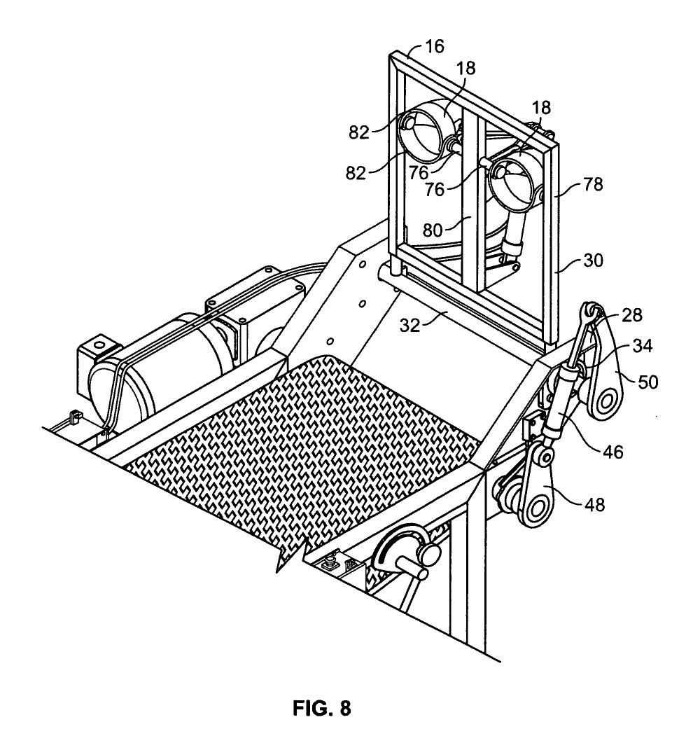

As shown in FIG. 6, each produce holding cup 22 comprises a substantially dished upper portion 104 coupled to a substantially cylindrical lower portion 106 where the cylindrical lower portion is coupled to a base 108. This configuration enables each produce holding cup to conformably hold produce such as broccoli and cauliflower in an upside down, inverted, orientation. In this embodiment, the shape and size of the dished upper portion, substantially cylindrical lower portion, and base of the produce holding cup is configured to conform to the size and shape of broccoli. A shown in FIG. 7, the produce holding cups are aligned in rows and two columns along the length of the produce cutting machine 10.

Referring back to FIG. 1, the produce holding cups 22 are coupled to the outer surface of the conveyor belt 38 by a plurality of nut and bolt couplings that span through the spaces in the interwoven belt. The bolts extend from the base 108 (shown in FIG. 6) of the produce holding cups through the conveyor belt and are secured by nuts located on the inner surface of the conveyor belt. Alternatively, the produce holding cups may be coupled to the conveyor belt by other suitable means including but not limited to adhesive fittings, snap fittings, and interlocking fittings.

Referring now to FIG. 7, the rows of produce holding cups 22 are spaced apart so that workers have enough time and space to place produce in the produce holding cups as the produce cutting machine 10 is operating. The space in between the rows of produce holding cups is constant around the entire surface area of the interwoven belt although in an alternative embodiment it may be varied depending on application. Each row of the produce holding cups is aligned along the width of the conveyor belt 38 such that workers from each side of the produce cutting machine may place produce in the produce holding cups at or about the same time.

The rows of produce holding cups 22 are spaced apart from each other such that the distance the conveyor belt travels in one full cycle of the pivoting cutting frame 16 corresponds to the distance between the center point of adjacent rows of produce holding cups. In this configuration, the produce holding cups do not interfere with the opening and closing of the cutting assemblies 18 or with the up and down movement of the pivoting cutting frame. In an alternative embodiment, there may be more or less rows of produce holding cups whereby one or more workers on each side of a produce cutting machine may place produce into multiple rows at or about the same time such that the speed of a endless conveyor, pivoting cutting frame, and plurality of cutting assemblies may be correspondingly increased to cut more produce. Produce holding cups may also be spaced farther apart along a conveyor belt to accommodate worker, produce, and cutting requirements.

Referring back to FIG. 1, broccoli is held within the produce holding cups 22 at a predetermined height in relation to the cutting assemblies 18 (when the pivoting cutting frame 16 is in its lowered position as shown in FIGS. 10 and 11) for the production of florets. The produce holding cups are manufactured from stainless steel, and in this embodiment the individual components are welded together. Referring back to FIG. 6, the dished upper portions 104 are formed from a substantially circular piece of stainless steel sheet with an orifice therein and at least one cut from the outer diameter to its inner diameter of the circle. The flat material is placed in a v-press where it is pressed at consecutive predetermined locations to form a substantially dish-shaped object with two abutting ends corresponding to the cut mentioned above. The abutting ends are then welded together to finalize the substantially dish-shaped upper portion. The dished upper portion is then welded together with the cylindrical lower portion 106, which is then welded with the base portion 108 to form the produce holding cup. In the alternative, the produce holding cups may be manufactured from materials including, but not limited to, plastic, aluminum and other types of materials suitable for this food processing application as well as by other methods of manufacture.

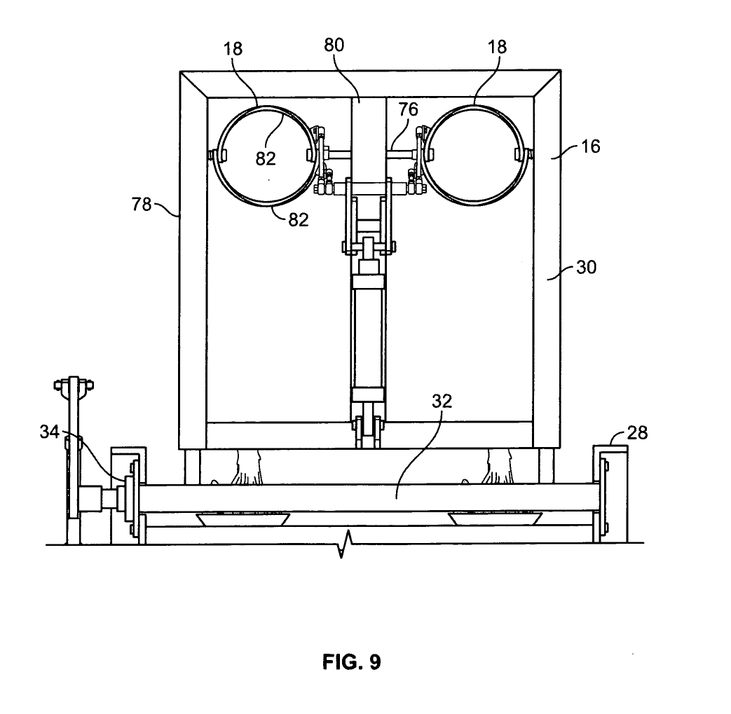

Referring now to FIG. 8, the pivoting cutting frame 16 includes a supporting frame 30 housing the cutting assemblies 18 and a pivoting axle 32 rigidly coupled to the supporting frame. The pivoting cutting frame is supported by the supporting brackets 28 and pivotally coupled to the supporting brackets by two bearings 34. As shown in FIG. 9, the cutting assemblies 18 are housed within the supporting frame 30 between outer elongate members 78 and an inner elongate member 80. Locating dowels 76 with threaded orifices therein are rigidly coupled to the inner elongate member and aligned with threaded orifices in the outer elongate members. Curved cutting blades 82 of the cutting assemblies 18 are coupled to the outer elongate members and the inner elongate member through a series of bearings and fasteners. In this configuration, bolts pass through the bearings into the threaded orifices of the outer elongate members and into the threaded orifices of the inner elongate members to secure the cutting assemblies to the supporting frame. Each set of two curved cutting blades overlaps at the bearing locations so that one bearing may support each side of the curved cutting blades where each cutting assembly uses two bearings for coupling to the supporting frame.

Each cutting assembly 18 includes two of the aforementioned opposed curved cutting blades 82 pivoting about a common axis of rotation corresponding to the center of the threaded orifices. The curved cutting blades are configured to define opened and closed positions. As shown in FIG. 10, where the pivoting cutting frame 16 is in the lowered position, and the curved cutting blades are in their open position, the curved cutting blades are configured to encircle a portion of produce. Furthermore, each curved cutting blade is shaped in a semicircular pattern substantially corresponding to the side profile of the branching of florets within the broccoli. As shown in FIG. 11, opposed curved cutting blades are also configured to overlap with each other in the closed position to completely cut produce. This portion of overlap is determined by the amount of downward movement of secondary connecting rods 84. As such, the amount of curved cutting blade overlap can be varied according to the length of the secondary connecting rods. The curved cutting blades are manufactured from stainless steel with sharpened ends to precisely cut the produce. In the alternative, titanium, aluminum, and other type of materials suitable for this food processing application may be used for the curved cutting blades.

Referring now to FIG. 10, each set of curved cutting blades 82 is coupled to an upper pivoting assembly 86 through two secondary connecting rods 84. The secondary connecting rods open and close the cutting assemblies 18 in connection with movement of the upper pivoting assembly. Each secondary connecting rod consists includes two rod ends 88 threaded onto a central rod 90. To either lengthen or shorten the secondary connecting rods, the threads of the rods ends may be adjusted as necessary. The upper portion of each set of two secondary connecting rods is coupled to a common pivoting point 92 on the upper pivoting assembly. The lower end of each set of secondary connecting rods is coupled to opposed curved cutting blades. In this configuration, the forward movement of the upper pivoting assembly forces the secondary connecting rods down to close the curved cutting blades (as shown in FIG. 11). Conversely, the backward movement of the upper pivoting assembly pulls the secondary connecting rods up to open the curved cutting blades. Accordingly, as the upper pivoting assembly is pivoted backwards and forwards, the secondary connecting rods open and close the cutting assemblies to encircle and cut produce, respectively.

The upper pivoting assembly 86 is coupled to and pivotable about a supporting mast 94. The upper pivoting assembly couples two sets of secondary connecting rods 84 with a telescoping rod 96 of a pneumatic actuator 98. The upper pivoting assembly rides in bearings positioned in the supporting mast and has inner and outer portions. The inner portion is coupled to the telescoping rod while the outer portion is coupled to the secondary connecting rods. When the telescoping rod extends, it pivots the upper pivoting assembly forward to force the secondary connecting rods downward to close the curved cutting blades 82. When the telescoping rod retracts, it pivots the upper pivoting assembly backward to pull the secondary connecting rods upwards to open the curved cutting blades. The upper pivoting assembly is manufactured from stainless steel members welded together. In the alternative, the upper pivoting assembly may be manufactured from other metals and materials suitable for use in connection with food processing machines and may alternatively by machined out of a single piece of material.

Referring still to FIG. 10, the supporting mast 94 is rigidly coupled to the pivoting cutting frame. An upper end of the supporting mast supports the upper pivoting assembly 86 with a pivoting coupling connection. The supporting mast is manufactured from stainless steel with components therein welded together. In the alternative, the supporting mast may be manufactured from other metals and materials suitable for use in connection with food processing machines and may alternatively by machined out of a single piece of material.

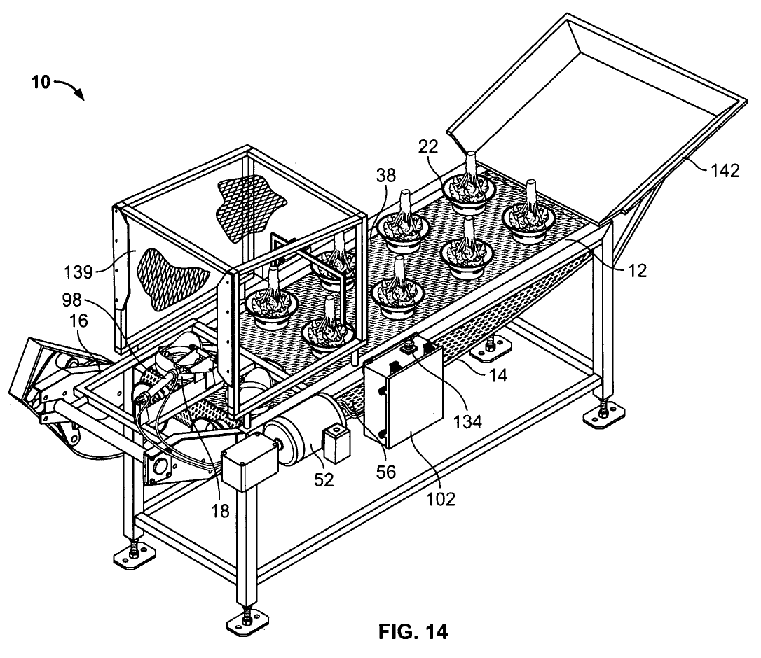

The pneumatic actuator 98 is pivotally coupled to the pivoting cutting frame 16 and the upper pivoting assembly 86. The pneumatic actuator has a telescoping rod 96, which extends and retracts depending on air pressure supplied by an air controller. When the telescoping rod extends, it pivots the upper pivoting assembly forward to push the secondary connecting rods 84 downward to close the curved cutting blades 82. When the telescoping rod retracts, it pulls the upper pivoting assembly 86 backwards to pull the secondary connecting rods upwards to open the curved cutting blades. The pneumatic actuator is conventional in manufacture, having an aluminum body and a stainless steel telescoping rod. The air controller is contained within a control unit 102 (shown in FIG. 14) and modulates air pressure to the pneumatic actuator to extend and retract the telescoping rod to cut the produce when the pivoting cutting frame is in the lowered position. In an alternative embodiment, other types of actuators including, but not limited to, hydraulic actuators and mechanical actuators may be used without departing from the scope of the invention.

In an alternative embodiment, cutting assemblies may be opened and closed by electric motors. The electric motors may be mounted over the cutting assemblies and configured to open and close curved cutting blades, rather than through pneumatic operation as shown in the accompanying figures. In this configuration, a pivoting cutting frame may include one or more cutting assemblies, which may be individually controlled by separate electric motors or controlled by more than one electric motor. The electric motors may be mechanically linked to the cutting assemblies and are not limited to being position directly over the cutting assemblies. Furthermore, in another alternative embodiment, an electric motor or actuator having sufficient speed and power to replace the pneumatic actuator may replace the pneumatic actuator.

In another alternative embodiment, cutting assemblies may include one curved cutting blade rather than the two curved cutting blades per cutting assembly as shown in the accompanying figures. In this configuration, a pneumatic actuator may still be configured to operate the cutting assemblies although an electric motor as described above may also be used. The curved cutting blades may be configured to complete a full sweep of the produce to be cut as opposed to the partial sweep of each opposed cutting blade as shown in the accompanying figures. Because there will be one blade rather two, the one blade must therefore pivot to cover the entire portion of the produce to be cut. Adjustments and changes to an upper pivoting assembly, secondary control rods, and a pneumatic cylinder may be made as necessary.

In another alternative embodiment, one cutting assembly may be housed in the pivoting frame rather than two cutting assemblies as shown in the accompanying figures. This configuration may permit the machine to be narrower and operable by one user. In this alternative embodiment, the produce cutting machine may be configured with one column of produce holding cups as opposed to the two columns shown in the accompanying drawings. With this configuration the costs and complexities of the produce cutting machine would likely be reduced. Similarly, in another alternative embodiment, more than two cutting assemblies may be housed in the pivoting frame rather than two cutting assemblies as shown in the accompanying figures. The columns of produce holding cups may similarly be increased to correspond with the cutting assemblies. In either alternative embodiment, the cutting assemblies may be actuated in a manner similar to the collection of secondary control rods, upper pivoting assembly, and pneumatic actuator as show in the accompanying figures. Additionally, the cutting assemblies in these alternative embodiments may have one curved cutting blade rather than two curved cutting blades per cutting assembly as discussed above.

Referring back to FIG. 2, the drive axle 42 is coupled to the rotational power source 20 and mounted on the produce cutting machine 10 through bearings within both sides of the supporting brackets 28. The drive axle is coupled to the crank 48 on a distal portion 118 and to the rotational power source on a proximal portion 120. The proximal portion is coupled to the rotating power source through a keyed coupling wherein the shaft runs through the gear box 52. Alternatively, the coupling may be an interference fit or other suitable means of coupling. In close proximity to the distal portion of the drive axle, a cam 114 is welded around the outer circumference of the drive axle. In an alternative embodiment, the cam may be machined on the drive axle. The distal end of the drive axle is welded to the crank, which rotates with the drive axle. The drive axle 42 has three injection molded plastic gears 44 coupled around its outer surface and spaced along the drive axle evenly. The plastic gears are configured to engagingly mesh with and rotate the conveyor belt 38. Depending on factors including, but not limited to, load and longevity, the number of gears may vary upon application. In an alternative embodiment, the gears may be manufactured from other materials including, but not limited to, other plastics, aluminum, and other type of materials suitable for this food processing application.

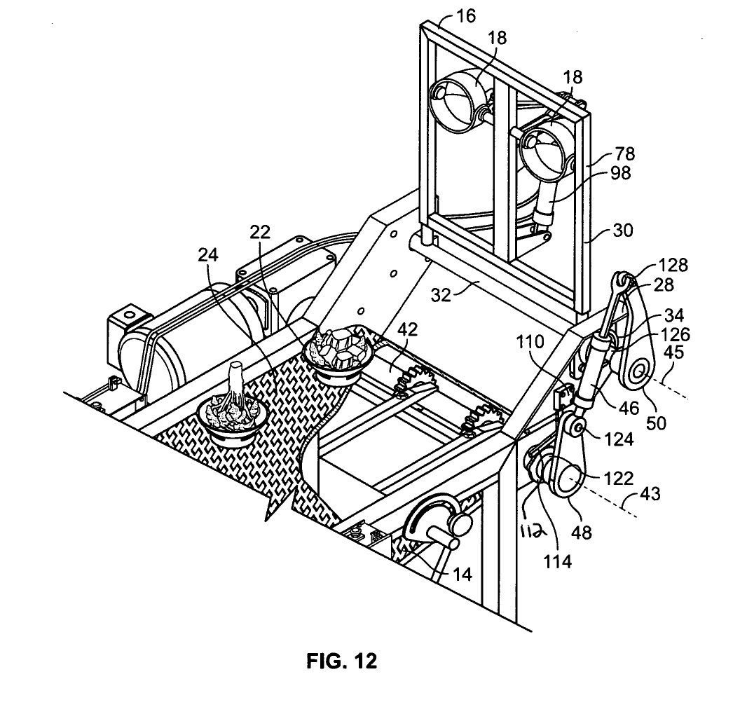

Referring now to FIG. 12, the crank 48 of the endless conveyor is rigidly coupled to the drive axle 42 and rotates in unison with the drive axle about the drive axle's rotational axis 43. The crank operates in connection with the primary connecting rod 46 and pivoting arm 50 to synchronize the endless conveyor 14 with the pivoting cutting frame 16. The crank is rigidly coupled to the drive axle at an inner location 122 and rotationally coupled to the primary connecting rod with a bearing and fastener at an outer location 124. The crank is manufactured from stainless steel. In the alternative, the crank may be manufactured from other metals and materials suitable for use in connection with food processing machines and may alternatively be fastened to the drive axle and primary connecting rod through other suitable means.

Still referring to FIG. 12, the pivoting arm 50 of the pivoting cutting frame 16 is rigidly coupled to the pivoting axle 32 and pivots in unison with the pivoting cutting frame about the pivoting axle's pivoting axis 45. The pivoting arm operates in connection with the primary connecting rod 46 and crank 48 to synchronize the pivoting cutting frame with the endless conveyor 14. The pivoting arm is rigidly coupled to the pivoting axle at an inner location 126 and pivotally coupled to the primary connecting rod at an outer location 128. The pivoting arm is manufactured from stainless steel. In the alternative, the pivoting arm may be manufactured from other metals and materials suitable for use in connection with food processing machines and may alternatively be fastened to the drive axle and primary connecting rod through other suitable means.

A snap action switch 110 incorporating a tensioned activator lever 112 operates in connection with the cam 114 to trigger the pneumatic actuator 98 to close the cutting assemblies 18 when triggered and to open the cutting assemblies when not triggered. In application, the tensioned activating lever follows the outer surface of the cam as the cam and drive axle 42 rotate in unison. The cam incorporates a high point thereon which corresponds to a row of produce holding cups 22 in the cutting location 24. In accordance with the aforementioned synchronization, the pivoting cutting frame 16 is in its lowered position when the high point of the cam is in full contact with the tensioned activator lever. When the high point of the cam compresses the tensioned activator lever, the snap action switch's circuit closes to trigger the air controller to pressurize the pneumatic actuator to extend the telescoping rod 96. As mentioned above, when the telescoping rod extends, it pushes the upper pivoting assembly 86 forward, which in turn pushes the secondary connecting rods 84 downward to close the cutting assemblies and cut the produce. Similarly, after the high point of the cam passes the tensioned activator lever, thus releasing pressure on the tensioned activator lever, the snap action switch circuit opens to signal the air controller to depressurize the pneumatic actuator, thus retracting the telescoping rod, which in turns pulls backward on the upper pivoting assembly, which in turn pulls upward on the secondary connecting rods to open the cutting assemblies so that the cycle may be repeated.

The cam 114 is manufactured from stainless steel and welded to the drive axle 42. However, in an alternative embodiment, a cam may be manufactured from aluminum, and other type of materials suitable for this food processing application. In an alternative embodiment, a cam may also be machined on the distal end of the drive axle. In another alternative embodiment, the positional sensor may comprise a magnetic sensor whereby the drive axle is coupled to a magnetized component configured to activate the magnetic sensor when a row of produce holding cups 22 is located in the cutting location 24. When the magnetic sensor is activated, it triggers the air controller to extend the telescoping rod 96 to close the cutting assemblies 18.

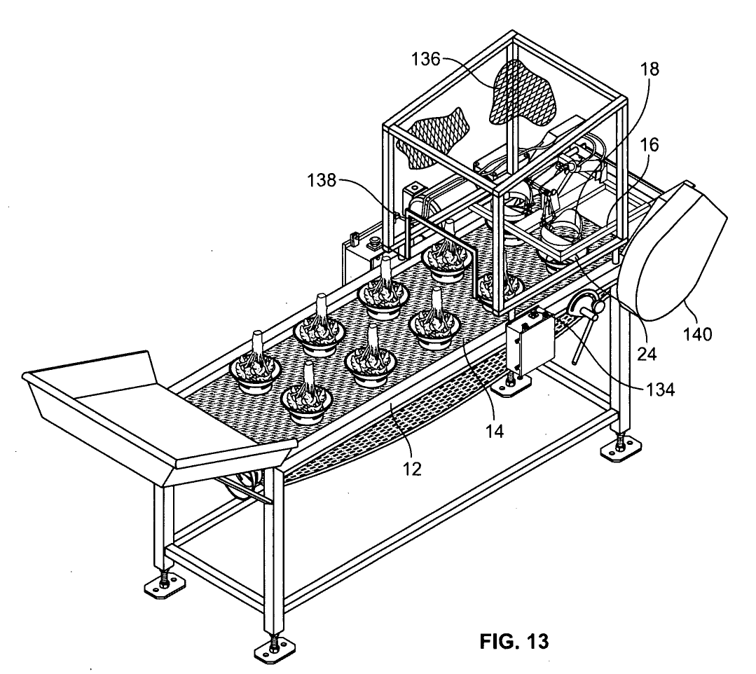

Referring now to FIG. 13, a side safety enclosure 140 is configured to contain moving parts including the primary connecting rod 46, crank 48 and pivoting arm 50 (as shown in FIG. 12). The side safety enclosure prevents users from accidentally catching clothing or body parts in the moving parts involved in synchronizing the endless conveyor 14 with the pivoting cutting frame 16, namely the primary connecting rod, crank, and pivoting arm. The side safety enclosure may be manufactured from pieces of stainless steel cut from a sheet and then welded together to form the enclosure. A box-like safety cage 136 comprised of stainless steel wire mesh is coupled to the supporting frame 12 to substantially enclose the pivoting cutting frame and cutting assemblies 18 housed therein. The front of the safety cage has an opening 138 large enough to allow produce to enter into the cutting location 24 yet sized moderately enough so as to reasonably prevent operators from accidentally catching clothing or body parts in the cutting assemblies.

Referring to FIG. 14, an outside electrical power source provides alternating current power to the produce cutting machine 10. The produce cutting machine also incorporates a transformer within the control unit 102 to convert the alternating current to direct current to power the electric motor 52. The control unit controls power to the motor and regulates the pressurized air through the previously mentioned air controller for use in connection with extending and retracting the telescoping rod 96 of the pneumatic actuator 98 (as shown in FIG. 10). Readily accessible emergency cut-off buttons 134 are located on each side of the produce cutting machine. When activated, the emergency cut-off buttons immediately cut power to the produce cutting machine, thus effectively shutting down the movement of the endless conveyor 14, pivoting cutting frame 16, cutting assemblies 18, and the pneumatic actuator. As another safety precaution, side panels manufactured from stainless steel may be coupled to the sides of the produce cutting machine 10 to prevent workers from catching their clothing or parts of their body in the endless conveyor and produce holding cups 22 rotating along the lower run 56.

Still referring to FIG. 14, the rear of the safety cage 136 has another opening 139, which is sufficiently sized for performing maintenance and repair on the pivoting cutting frame and components housed therein. While the safety cage is made out of stainless steel wire mesh to prevent operators from catching body parts or clothing in the produce cutting machine 10, the wire mesh also enables operators to see into the pivoting cutting frame are of the machine to ensure that all of the components such as the cutting assemblies 18 and pneumatic actuator are functioning correctly.

A guiding tray 142 is coupled to the supporting structure 12 to help produce cutting machine 10 operators guide broccoli into the produce holding cups 22. The tray is angled slightly downward to assist the broccoli to travel towards the conveyor belt 38. Operators then correctly position the broccoli in an inverse orientation in the produce holding cups. The guiding tray is formed from pieces of stainless steel cut from a sheet and then welded together.

While several embodiments have been described in detail, it should be appreciated that various modifications and/or variations may be made without departing from the scope or spirit of the invention. In this regard it is important to note that practicing the invention is not limited to the applications described herein above. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein above. Thus, it is intended that the invention cover all such embodiments and variations as long as such embodiments and variations come within the produce cutting machine of the appended claims and its equivalents.

What is claimed is:

1. A produce cutting machine comprising:
a supporting structure;
an endless conveyor coupled to the supporting structure;
a plurality of produce holding cups coupled to the endless conveyor, the produce holding cups conveyable to and from a cutting location;
a plurality of cutting assemblies comprising two curved cutting blades, the curved cutting blades defining cutting assembly opened and closed positions;
an actuator configured to open and close the cutting assemblies;
a pivoting cutting frame housing the cutting assemblies, the pivoting cutting frame coupled to the supporting structure and pivotable between a lowered position and a raised position;
a primary connecting rod synchronizing the endless conveyor with the pivoting cutting frame such that the produce holding cups and cutting assemblies cyclically converge to and diverge from the cutting location; and
a positional sensor configured to trigger the actuator to close the cutting assemblies when the produce holding cups and the cutting assemblies converge at the cutting location.

2. The produce cutting machine of claim 1, wherein:
the endless conveyor comprises:
a conveyor belt;
a rotational power source;
a drive axle coupled to the rotational power source, the drive axle having a drive axle rotational axis; and
a plurality of gears coupled to the drive axle;
wherein the gears are configured to drive the conveyor belt.

3. The produce cutting machine of claim 2, wherein:
the pivoting cutting frame comprises:
a supporting frame housing the cutting assemblies;
a pivoting axle rigidly coupled to the supporting frame, the pivoting axle pivotally coupled to the supporting structure and having a pivoting axle pivoting axis;
a pivoting arm coupled to the pivoting axle;
the endless conveyor further comprises:
a crank coupled to the drive axle;
wherein the primary connecting rod couples the pivoting arm to the crank to rotationally couple the pivoting cutting frame with the endless conveyor, the pivoting arm moving in an arc defining a pivoting arm radius and the crank moving in a circle defining a crank radius.

4. The produce cutting machine of claim 2, wherein:
the pivoting cutting frame comprises:
a supporting frame coupled to the cutting assemblies;
a plurality of tabs protruding from the supporting frame; and
a pivoting arm coupled to the supporting frame;
the endless conveyor further comprises:
a crank coupled to the drive axle;
wherein the tabs pivotally couple the supporting frame to the supporting structure;
wherein the primary connecting rod couples the pivoting arm to the crank to rotationally couple the pivoting cutting frame with the endless conveyor.

5. The produce cutting machine of claim 3, wherein:
the pivoting arm and crank are sized such that the pivoting arm radius is larger than the crank radius such that a complete revolution of the drive axle rotates the pivoting cutting frame less than a complete revolution.

6. The produce cutting machine of claim 5, wherein:
the pivoting arm and crank are sized such that the pivoting arm radius is greater than the crank radius in an amount such that approximately one hundred and eighty degrees of crank rotation corresponds to approximately ninety degree of pivoting cutting movement.

7. The produce cutting machine of claim 6, wherein:
a plurality of secondary connecting rods couple the curved cutting blades to an upper pivoting assembly;
the upper pivoting assembly is pivotally coupled to a supporting mast, the supporting mast coupled to the supporting frame;
the actuator is a pneumatic actuator with a cylinder and a telescoping rod, the cylinder coupled to the supporting frame and the telescoping rod coupled to the upper pivoting assembly;
wherein the positional sensor is configured to trigger the pneumatic actuator to extend the telescoping rod and pivot the upper pivoting assembly forward about the supporting mast to move the secondary connecting rods downward to close the curved cutting blades.

8. The produce cutting machine of claim 7, wherein:
the positional sensor comprises a snap action switch having a tensioned activating lever; and
the drive axle is coupled to a cam having a contoured outer surface including a lobe configured to compress the tensioned activating lever, the lobe corresponding to a row of produce holding cups in the cutting location;
wherein the tensioned activating lever is configured to follow the cam's contoured outer surface and trigger the telescoping rod of the pneumatic actuator to extend when the lobe compresses the tensioned activating lever.

9. The produce cutting machine of claim 7, wherein:
the positional sensor comprises a magnetic sensor; and
the drive axle is coupled to a magnetized component configured to activate the magnetic sensor when a row of produce holding cups are in the cutting location;
wherein the magnetic sensor is configured to trigger the telescoping rod to extend when the magnetized component activates the magnetic sensor.

10. The produce cutting machine of claim 8, wherein:
the supporting structure comprises an elongate frame with supporting brackets coupled thereto;
wherein the pivoting cutting frame is pivotally coupled to the supporting brackets; and
wherein the endless conveyor is coupled to the elongate frame and configured to convey the produce holding cups substantially horizontally along an upper run of the conveyor belt from an intake section of the machine to the cutting location of the machine.

11. The produce cutting machine of claim 10, wherein:
the conveyor belt comprises an interwoven belt with inner and outer surfaces; and
a base of each cup is coupled to the outer surface of the interwoven belt by a plurality of nut and bolt couplings wherein the bolts extend from base of the cups through the interwoven belt and are secured by nuts located on the inner surface of the interwoven belt.

12. The produce cutting machine of claim 10, wherein:
the conveyor belt comprises a plurality of chains spanning longitudinally along the machine, the plurality of chains and coupled transversely by a plurality of rigid beams having inner and outer surfaces; and
a base of each cup is coupled to the outer surface of a beam by a plurality of nut and bolt couplings wherein the bolts extend from base of the cups through the beam and are secured by nuts located on the inner surface of a beam.

13. The produce cutting machine of claim 11, wherein:
the upper run of the interwoven belt is configured to slide along longitudinal elongate members within the elongate frame; and
wherein the longitudinal elongate members are pivotally coupled to a distal portion of the elongate frame and supported on a proximal portion by a rotating cylinder of a conveyor height-adjusting mechanism.

14. The produce cutting machine of claim 13, wherein:
the interwoven belt is supported on a proximal end by the gears coupled to the drive axle and supported on a distal end by a curved sheet; and
the curved sheet is configured so that the interwoven belt may slidably rotate about the curved sheet.

15. The produce cutting machine of claim 13, wherein:
the interwoven belt is supported on a proximal end by the gears coupled to the drive axle and supported on a distal end by a plurality of wheels; and
the wheels are configured to interface with the interwoven belt so that the interwoven belt rotate in connection with the rotation of the wheels.

16. The produce cutting machine of claim 14, wherein:
the power source comprises a hydraulic motor;
wherein the hydraulic motor is coupled directly to the drive axle.

17. The produce cutting machine of claim 14, wherein:
the power source comprises an electric motor coupled to a gearbox;
wherein the gearbox is coupled directly to the drive axle.

18. The produce cutting machine of claim 16, wherein:
each produce holding cup comprises:
a substantially dished upper portion coupled to a substantially cylindrical lower portion, the cylindrical lower portion coupled to the base;
wherein each cup is configured to hold produce in an inverse orientation.

19. The produce cutting machine of claim 18, wherein:
a hood is coupled to the supporting structure, the hood substantially enclosing the pivoting cutting frame and cutting assemblies and having openings therein to allow produce to pass through.

20. The produce cutting machine of claim 19, wherein:
an enclosure is coupled to a side of the supporting structure, the enclosure substantially enclosing the crank, primary connecting rod, and pivoting arm.

21. A produce cutting machine comprising:
a supporting structure;
an endless conveyor coupled to the supporting structure;
a plurality of produce holding cups coupled to the endless conveyor and conveyable to and from a cutting location, the produce holding cups configured to accept produce therein;
a pivoting cutting frame coupled to the supporting structure;
a plurality of cutting assemblies housed in the pivoting cutting frame, the cutting assemblies configured with curved cutting blades;
a primary connecting rod synchronically coupling the endless conveyor with the pivoting cutting frame such that the produce holding cups and cutting assemblies periodically converge at the cutting location;
an actuator configured to open and close the cutting assemblies; and
a positional sensor configured to trigger the actuator to close the cutting assemblies when the produce holding cups and cutting assemblies converge at the cutting location.

22. The produce cutting machine of claim 21, wherein:
the endless conveyor comprises:
a conveyor belt;
a hydraulic motor;
a drive axle coupled to the hydraulic motor; and
a plurality of gears coupled to the drive axle.

23. The produce cutting machine of claim 22, wherein:
a pivoting arm is coupled to the pivoting cutting frame, the pivoting arm pivoting about a pivoting axle pivoting axis;
a crank is coupled the drive axle, the crank rotating about a drive axle rotational axis;
wherein an upper end of the primary connecting rod is coupled to the pivoting arm and a lower end of the primary connecting rod is coupled to the crank to synchronically coupling the endless conveyor with the pivoting cutting frame.

24. The produce cutting machine of claim 23, wherein:
the movement of the upper end of the primary connecting rod defines a first radius about the pivoting axle pivoting axis; and
the movement of the lower end of the primary connecting rod defines a second radius about the drive axle rotational axis;
wherein the first radius is larger than the second radius.

25. The produce cutting machine of claim 24, wherein:
a plurality of secondary connecting rods couple the curved cutting blades to an upper pivoting assembly;
the upper pivoting assembly is pivotally coupled to a supporting mast;
the supporting mast is coupled to the supporting frame; and
the actuator is a pneumatic actuator coupled between the pivoting frame and the upper pivoting assembly.

26. The produce cutting machine of claim 25, wherein:
the conveyor belt comprises an interwoven belt.

27. The produce cutting machine of claim 26, wherein:
the interwoven belt slides along longitudinal elongate members coupled to the supporting structure; and
the longitudinal elongate members comprise a substantially smooth top portion over which the interwoven belt slides.

28. The produce cutting machine of claim 27, wherein:
the interwoven belt is supported on a first end by the drive axle and supported on a second end by a curved sheet; and
the curved sheet has a smooth surface for slidably interfacing with the interwoven belt.

29. The produce cutting machine of claim 28, wherein:
each produce holding cup comprises a substantially dished upper portion configured to conformably hold produce in an inverted position.

30. A produce cutting machine comprising:
a supporting structure;
an endless conveyor coupled to the supporting structure;
a plurality of produce holding cups coupled to the endless conveyor and conveyable to and from a cutting location;
a pivoting cutting frame coupled to the supporting structure and pivotable to and from a cutting location; and
a plurality of cutting assemblies housed within the pivoting cutting frame, the cutting assemblies configured with curved cutting blades;
wherein the endless conveyor and the pivoting cutting frame are synchronized such that the produce holding cups and cutting assemblies periodically converge at the cutting location;
wherein a positional sensor triggers an actuator to close the cutting assemblies when the produce holding cups and cutting assemblies converge at the cutting location.

31. The produce cutting machine of claim 30, wherein:
the endless conveyor comprises:
an interwoven conveyor belt;
a hydraulic motor;
a drive axle coupled to the hydraulic motor; and
a plurality of gears coupled to the drive axle, the gears configured to rotate the interwoven belt;

32. The produce cutting machine of claim 31, wherein:
a primary connecting rod synchronically couples the pivoting cutting frame to the endless conveyor.

33. The produce cutting machine of claim 32, wherein:
the pivoting cutting frame pivots between a first substantially horizontal position and a second, substantially vertical position.

34. The produce cutting machine of claim 33, wherein:
the actuator is a pneumatic actuator.

35. The produce cutting machine of claim 34, wherein:
the interwoven belt slides along longitudinal elongate members coupled to the supporting structure; and
the longitudinal elongate members comprise a substantially smooth top portion over which the interwoven belt slides.

36. The produce cutting machine of claim 35, wherein:
the interwoven belt is supported on a first end by the drive axle and supported on a second end by a curved sheet;
wherein the curved sheet has a smooth outer surface on which the interwoven belt slides.

37. The produce cutting machine of claim 36, wherein:
each cup comprises a substantially dished upper portion configured to conformably hold produce therein.

38. A produce cutting machine comprising:
a supporting structure comprising an elongate frame with supporting brackets coupled thereto;
an endless conveyor coupled to the elongate frame, the endless conveyor comprising an interwoven belt, a hydraulic motor coupled to a drive axle, and a plurality of gears coupled to the drive axle and configured to drive the interwoven belt;
wherein the drive axle has a drive axle rotational axis and a crank coupled thereto;
wherein the endless conveyor is configured to convey produce holding cups substantially horizontally along an upper run of the interwoven belt from an intake location to a cutting location;
wherein the interwoven belt slides along longitudinal elongate members;
wherein the interwoven belt is supported on a proximal end by the gears coupled to the drive axle and supported on a distal end by a curved sheet;
wherein the curved sheet is configured so that the interwoven belt may slidably rotate about the curved sheet;
a plurality of produce holding cups coupled to the interwoven belt, the produce holding cups arranged in a plurality of rows and columns and conveyable to and from the cutting location and configured to hold produce therein;
wherein a base of each produce holding cup is coupled to an outer surface of the interwoven belt by a plurality of nut and bolt couplings;
a plurality of cutting assemblies, each cutting assembly comprising a set of two opposed curved cutting blades having a common axis of rotation, the curved cutting blades defining cutting assembly opened and closed positions;
a pivoting cutting frame comprising a supporting frame housing the cutting assemblies, a pivoting axle rigidly coupled to the supporting frame and pivotally coupled to the supporting brackets of the supporting structure, the pivoting axle having a pivoting axle pivoting axis, and the pivoting cutting frame also comprising a pivoting arm coupled to the pivoting axle;
wherein the pivoting cutting frame is configured to pivot between a lowered position and a raised position;
a primary connecting rod coupling the pivoting arm to the crank and configured to rotationally couple the pivoting cutting frame with the endless conveyor;
wherein the endless conveyor and pivoting cutting frame are synchronized such that the produce holding cups and cutting assemblies converge at the cutting location;
a plurality of secondary connecting rods coupling the curved cutting blades to an upper pivoting assembly;
wherein the upper pivoting assembly is pivotally coupled to a supporting mast, the supporting mast coupled to the pivoting cutting frame;
a pneumatic actuator with a cylinder and a telescoping rod, the cylinder coupled to the pivoting cutting frame and the telescoping rod coupled to the upper pivoting assembly;
wherein a positional sensor is configured to trigger the pneumatic actuator to close the cutting assemblies to cut the produce when the produce holding cups and cutting assemblies converge at the cutting location.

39. A produce cutting machine comprising:
a supporting structure;
a conveying means coupled to the supporting structure, the conveying means configured to transport a plurality of produce holding cups from an intake location to a cutting location;
a cutting means coupled to the supporting structure, the cutting means configured to cut produce in the cutting location;
a coupling means configured to synchronically couple the conveying means with the cutting means such that when the produce holdings cups are conveyed to the cutting location, the cutting means cuts the produce within the produce holding cups.

40. A method of cutting produce comprising:
accepting produce in produce holding cups coupled to an endless conveyor, the endless conveyor comprising an interwoven belt and a rotational power source configured to rotate the interwoven belt;
conveying the produce within the produce holding cups along the endless conveyor to a cutting location;
lowering a pivoting cutting frame to position cutting assemblies therein within a cutting location; and
closing the cutting assemblies to cut the produce in the produce holding cups.

41. A method of cutting produce comprising:
accepting produce in produce holding cups affixed to an endless conveyor;
conveying the produce in the produce holding cups to a cutting location;
lowering cutting assemblies within a pivoting cutting frame to the cutting location; and
closing the cutting assemblies to cut the produce within the produce holding cups.
